(19) United States
(12) Patent Application Publication
(10) Pub. No.: US 2002/0197464 A1
(43) Pub. Date: Dec. 26, 2002

(54) Shaped thermal insulation body

(76) Inventors: Robert Kicherer, Oberderdingen (DE); Guenter Kratel, Durach (DE); Bernhard Mikschl, Sulzfeld (DE); Erich John, Pforzheim (DE); Matthias Mangler, Karlsbad (DE)

Correspondence Address: AKERMAN, SENTERFITT & EDISON, P.A., SUITE 400, 222 LAKEVIEW AVENUE, WEST PALM BEACH, FL, 33401, US

(21) Appl. No.: 10/084,099

(22) Filed: Feb. 27, 2002

(30) Foreign Application Priority Data
Feb. 28, 2001 (DE) 10110731.5

(51) Int. Cl. B32B 18/00

(52) U.S. Cl. 428/293.4

(57) ABSTRACT

A shaped thermal insulation body comprises molded and/or sintered thermal insulation material and contains fumed silica, inorganic fillers, opacifiers and fibers. The BET surface of the thermal insulation material is below 100 m²/g, e.g. between 10 and 100 m²/g, so that the shaped thermal insulation body absorbs less water. In the case of radiant heaters, the shaped thermal insulation body can be used as a base for heating resistors.

The invention relates to a shaped thermal insulation body comprising a moulded and/or sintered thermal insulation material-containing fumed silica, inorganic fillers, opacifiers and fibres.

Such shaped thermal insulation bodies are known and are e.g. described in EP 618 399 B1. To obtain good thermal insulation characteristics, the thermal insulation materials of these shaped thermal insulation bodies have very high specific surfaces, which are in the range of min. 120 m²/g (measured according to BET, as described in ASTM Special Technical Publication no. 51, p 1941 ff).

As a result of these large surfaces and the fact that the main constituent of the thermal insulation material of the described shaped thermal insulation bodies is fumed silica, which is known to carry silanol groups on its surface and which is therefore highly hydrophilic, the absorption capacity of such materials with respect to water is very marked. If such a shaped body is exposed in practical use within a short time to a high thermal energy, water vapour is formed in explosive manner and destroys the structure of the shaped body.

This effect e.g. occurs in thermally insulating shaped bodies, which are used as thermal insulation in radiant heaters for ceramic cooking zones, the radiant heaters typically being made to glow in 1 to 5 seconds. In order to obtain an increase in the diffusion of water vapour from the interior to the surface of the shaped body and therefore to avoid local overpressure in the interior of the shaped body and which would destroy the structure of said body, the hitherto described shaped thermal insulation bodies have channel pores. However, these channel pores suffer from the decisive disadvantage that they deteriorate the thermal insulation characteristics. There is also a reduction in the mechanical stability of the material. In addition, the formation of such pores involves additional labour and costs.

Another problem is that the water vapour occurring on heating condenses at colder points, inter alia on electronic components, which can lead to faults in the electronics.

The problem of the invention is the provision of a shaped thermal insulation body, whose thermal insulation material has such a reduced water adsorption potential that water vapour problems can be eliminated. The insulating characteristics are to remain at an optimum.

According to the invention this problem is solved by a shaped thermal insulation body having the features of claim 1. Preferred developments of the shaped thermal insulation body according to the invention are characterized in the subclaims. By express reference the subject matter of the claims is made into part of the content of the description.

The advantages obtained with the invention are that by reducing the BET surface of the thermal insulation material to in all approximately 10 to 100 m²/g, the water adsorption capacity can be lowered. Even in the case of shock heating, the shaped thermal insulation body according to the invention maintains its structure and channel bores and the like are not required.

The thermal insulation material used in preferred manner according to the invention has the following composition:

1 to 70 wt. % fumed silica,

10 to 55 wt. % opacifier and

1 to 10 wt. % fibrous material.

It preferably contains 1 to 35 wt. % inorganic fillers. Advantageously 0 to 15 wt.% stabilizers can be contained.

Particularly preferred compositions contain:

35 to 50 wt. % fumed silica,

30 to 40 wt. % opacifier,

5 to 25 wt. % inorganic fillers,

5 to 10 wt. % stabilizers and

approximately 3 wt. % fibrous material.

Advantageously the fumed silicas have a BET surface of 50 to 200 m²/g. The amount of fumed silica used, which is preferably between 35 and 50 wt. %, is a function of the BET surface. The higher the BET surface the lower the amount used.

At a measuring temperature of 400° C., the thermal conductivity is less than 0.035 W/mK and is in particular approximately 0.025 W/mK. At 1000° C. this corresponds to approximately 0.08 W/mK.

The opacifier used can be ilmenite, titanium oxide/rutile, iron II/iron III mixed oxide, chromium oxide, zirconium oxide and mixtures thereof. Advantageously use is made of zirconium silicate and silicon carbide.

Examples of fillers are metal oxides and hydroxides of the III and IV main group and/or the IV auxiliary group of the periodic system. Oxides of silicon, aluminium, zirconium and titanium are preferably used. Examples are e.g. for silicon arc silica or precipitated silica aerogels, for aluminium Al₂O₃ or Al(OH)₃ and for titanium rutile. It is also possible to use mixtures thereof. Advantageously arc silica and aluminium oxides are used. The BET surfaces are between 1.5 and 25 m²/g with a proportion of 10 to 30 wt. %.

To increase stability, the material advantageously contains stabilizers. These stabilizers are preferably oxides or hydroxides of aluminium, such as e.g. Al₂O₃, AlO(OH) and Al(OH)₃. For stabilization purposes it is also possible to use phosphates, such as e.g. calcium hydrogen pyrophosphate.

Examples of fibrous materials are ceramic fibres of a soluble and insoluble type, quartz glass fibres, silica fibres, fibres with a SiO₂ content of at least 96 wt. % and glass fibres such as E-glass fibres and R-glass fibres, as well as mixtures of one or more of the indicated fibre types. They preferably have a diameter greater than 6 micrometers and a length of 1 to 25 mm.

On the one hand the material can be pressed as a compacted mixture into reception parts such as trays or the like. On the other hand it can be moulded to shaped bodies without any covering and subsequently sintered at temperatures of 400 to 1000° C. For this purpose use can be made of sintering aids and examples thereof are disclosed in EP 29 227. Preference is given to the use of borides of aluminium, zirconium, calcium and titanium, particularly boron carbide.

There follows a comparison with respect to a shaped thermal insulation body between a conventional comparison mixture and two mixtures according to the invention.

The tests were carried out with a shaped thermal insulation body (STIB) with a diameter of 180 mm. The mixtures were mixed in a cyclone mixer at 3000 r.p.m. for 5 min., the weight being 1 kg. The STIB was pressed on a hydraulic press at a pressure of approximately 25 kg/cm².

1) Comparison mixture:
60 wt. % silica BET surface 200 m²/g
2.5 wt. % silica fibres
37.2 wt. % zirconium silicate BET surface 13 m²/g
0.3 wt. % boron carbide
total BET surface 125 m²/g
STIB weight 135 g
STIB density 0.35 g/cm³
Plate temperature on outer base 235° C.
STIB in moist area at 30° C. and 93% relative atmospheric humidity:
Moisture absorption: 24 h 11.5 g
48 h 13.3 g
168 h 14.6 g
2) First mixture according to the invention with zirconium silicate:
40 wt. % silica BET surface 130 m²/g
2 wt. % silica fibres
35 wt. % zirconium silicate BET surface 13 m²/g
18 wt. % arc silica BET surface 30 m²/g
5 wt. % aluminium hydroxide BET surface 8 m²/g
total BET surface 65 m²/g
STIB weight 135 g
STIB density 0.35 g/cm³
Plate temperature at outer base 244° C.
STIB in moist space at 30øC and 93% relative atmospheric humidity:
Moisture absorption: 24 h 4.2 g
48 h 5.0 g
168 h 6.1 g
Reduction of water absorption by 58% compared with the comparison mixture.
3) Second mixture according to the invention with silicon carbide:
40 wt. % silica BET surface 130 m²/g
2 wt. % silica fibres
35 wt. % silicon carbide BET surface 13 m²/g
18 wt. % arc silica BET surface 30 m²/g
5 wt. % aluminium oxide BET surface 8 m²/g
total BET surface 65 m²/g
STIB weight 135 g
STIB density 0.35 g/cm³
Plate temperature at outer base 235° C.
STIB in moist space at 30° C. and 93% relative atmospheric humidity:
Moisture absorption: 24 h 4.1 g
48 h 4.7 g
168 h 5.1 g
Reduction of water absorption by 65% compared with the comparison mixture.

After storing for 168 h in the moist area and in the case of rapid glowing (within 4 sec), mixtures 2) and 3) reveal no structural changes and in particular no swelling or bursting. The other characteristics of the shaped thermal insulation body were retained. The thermal insulation action of mixture 3) is as good as in the comparison mixture.

These and further features can be gathered from the claims, description and drawings and individual features, both singly and in the form of subcombinations, can be implemented in an embodiment of the invention and in other fields and can represent patentable forms for which protection is claimed here. The subdivision of the application into individual sections and the subtitles in no way restrict the general validity of the statements made thereunder.

An embodiment of the invention is described hereinafter relative to the drawings, wherein show:

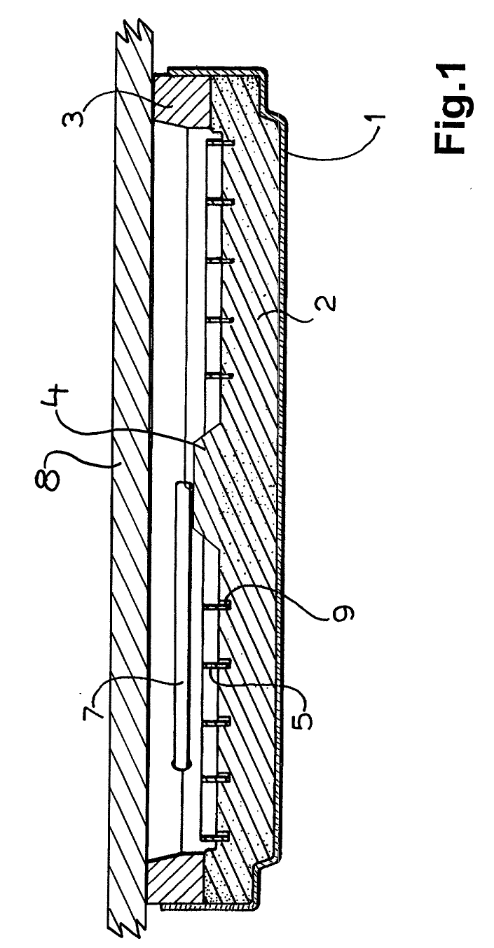

FIG. 1 A section through a radiant heater with a shaped thermal insulation body according to the invention.

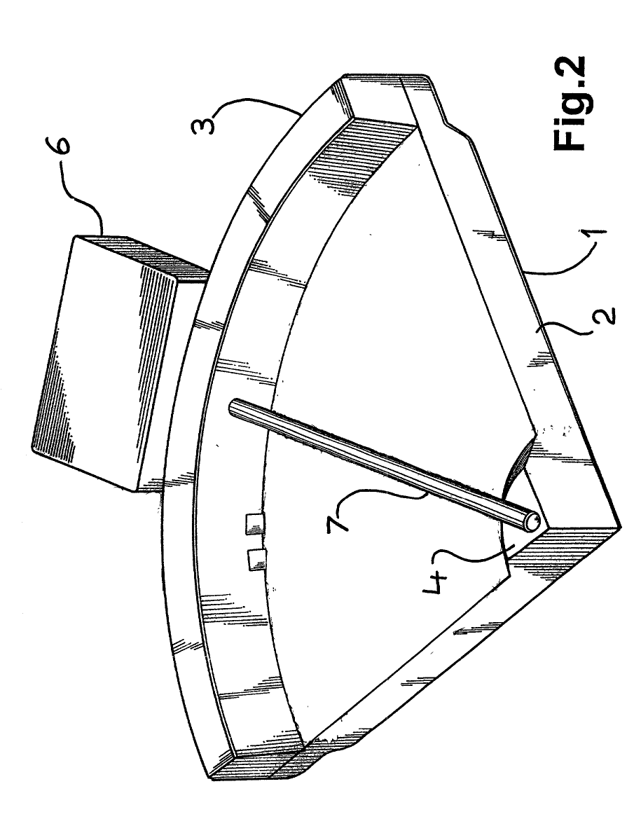

FIG. 2 An inclined view of the radiant heater of FIG. 1.

FIGS. 1 and 2 show an electric radiant heater, which is pressed onto the underside of a glass ceramic plate 8. The radiant heater has a reception tray 1, preferably of sheet metal and in it is inserted as the base 2 a shaped thermal insulation body. The base 2 in known manner carries heating resistors 5 in recesses 9.

In the central area the base 2 has a frustum-shaped protuberance 4, which serves as a support for the temperature sensor 7 of the temperature controller 6. This is adequately known from the prior art.

Within the reception tray 1, an external, circumferential edge or border 3 rests on the outer area of the base 2. Said edge 3 serves as a spacer in order to keep the radiant heater at a predetermined distance from the glass ceramic plate 8. It also forms a thermal insulation to the side.

To facilitate understanding, in FIG. 2 the heating resistors 5 and associated recesses 9 are not shown.

The drawings make it clear that the requirements on the thermal insulation in the form of base 2 and the spacer in the form of edge 3 are different. The base 2 carries the heating resistor 5 and is consequently exposed to higher temperatures. Significance is again attached to the improved compatibility of the rapid heating. It must also be constructed for the fastening of the heating resistors 5.

The edge 3 requires a certain strength, particularly compression strength, in order to be able to absorb the contact pressure. In addition, there are thermal insulation requirements.

1. Shaped thermal insulation body comprising moulded and/or sintered thermal insulation material-containing fumed silica, inorganic fillers, opacifiers and fibres, the BET surface of the thermal insulation material being below 100 m²/g.

2. Shaped thermal insulation body according to claim 1, wherein the BET surface of the thermal insulation material is 10 to 100 m²/g.

3. Shaped thermal insulation body according to claim 1, wherein after storing in a moist space, the shaped thermal insulation body absorbs 3 to 7 wt. % water, based on its weight.

4. Shaped thermal insulation body according to claim 3, wherein, after storing in a moist space, the shaped thermal insulation body absorbs approximately 5 wt. % water, based on its weight.

5. Shaped thermal insulation body according to claim 1, wherein the thermal conductivity at 400° C. is below 0.045 W/mK.

6. Shaped thermal insulation body according to claim 5, wherein the thermal conductivity at 400° C. is approximately 0.025 W/mK.

7. Shaped thermal insulation body according to claim 1, wherein the proportion of fumed silica is less than 70 wt. %.

8. Shaped thermal insulation body according to claim 7, wherein the proportion of fumed silica is 30 to 50 wt. %.

9. Shaped thermal insulation body according to claim 1, wherein the BET surface of the fumed silica is 50 to 150 m²/g.

10. Shaped thermal insulation body according to claim 1, wherein the opacifier proportion is 10 to 50 wt. %.

11. Shaped thermal insulation body according to claim 10, wherein the opacifier proportion is approximately 35 wt. %.

12. Shaped thermal insulation body according to claim 1, wherein the opacifier is a silicon compound.

13. Shaped thermal insulation body according to claim 12, wherein the opacifier is SiC.

14. Shaped thermal insulation body according to claim 1, wherein the proportion of fibres is 1 to 10 wt. %.

15. Shaped thermal insulation body according to claim 14, wherein the proportion of fibres is approximately 2 wt. %.

16. Shaped thermal insulation body according to claim 1, wherein the thermal insulation material contains inorganic hardening agents.

17. Shaped thermal insulation body according to claim 16, wherein the thermal insulation material contains boron carbide.

18. Shaped thermal insulation body according to claim 1, wherein the thermal insulation material contains stabilizers.

19. Shaped thermal insulation body according to claim 18, wherein the thermal insulation material contains aluminium compounds as stabilizers.

20. Shaped thermal insulation body according to claim 18, wherein the stabilizer proportion is 1 to 10 wt. %.

21. Shaped thermal insulation body according to claim 20, wherein the stabilizer proportion is 3 to 8 wt. %.

22. Shaped thermal insulation body according to claim 1, wherein the thermal insulation material contains metal oxides of the III and IV main group and the IV auxiliary group of the periodic system.

23. Shaped thermal insulation body according to claim 22, wherein the thermal insulation material contains arc silica.

24. Shaped thermal insulation body according to claim 23, wherein the arc silica has a BET surface of 10 to 35 m²/g.

25. Shaped thermal insulation body according to claim 23, wherein the arc silica content is max. 35 wt. %.

26. Use of a shaped thermal insulation body according to claim 1 in a radiant heater of a cooking zone having a glass ceramic plate, the shaped thermal insulation body carrying the radiant heater.
